(19) United States
(12) Patent Application Publication
(10) Pub. No.: US 2009/0002349 A1
(43) Pub. Date: Jan. 1, 2009

(54) ELECTROLUMINESCENT WHITE LIGHT EMITTING DEVICE

(76) Inventors: Ronald S. Cok, Rochester, NY (US); Paul J. Kane, Rochester, NY (US)

Correspondence Address: David Novais;Patent Legal Staff, Eastman Kodak Company, 343 State Street, Rochester, NY, 14650-2201, US

(21) Appl. No.: 11/769,820

(22) Filed: Jun. 28, 2007

(51) Int. Cl. G06F 3/038

(52) U.S. Cl. 345/204

(57) ABSTRACT

A white-light-emitting electroluminescent device includes light-emitting elements for emitting different colors of light, wherein one of the light-emitting elements has a luminous efficacy greater than the luminous efficacy of at least one of the other light-emitting elements. The different colors of light combine to form white light. Also included is a driver for receiving a color signal representing a relative luminance and color produced by the electroluminescent device. The driver is responsive to a converted control signal when controlling the color accuracy of the light produced by the light-emitting elements to ultimately reduce the power consumption of the white light-emitting electroluminescent device.

### FIELD OF THE INVENTION

The present invention relates generally to electroluminescent white light emitting devices, and specifically to a method for reducing the power consumed by such a device.

### BACKGROUND OF THE INVENTION

Electroluminescent devices have many applications in lighting, information displays and imaging displays. Such applications include a myriad of battery powered, portable electronic devices such as laptop computers, personal digital assistants, personal media players, global positioning system (GPS) units, and cellular telephones, in which an electroluminescent device may serve as a self-luminous display, or as a backlight for a display. Portable lighting devices include flashlights, booklamps, and headlamps made with light-emitting diodes (LEDs). A common problem with portable devices is the limited time of operation before the battery must be replaced or recharged. One approach to saving power is to automatically put the device into a minimum power or sleep mode if there has been no active use of the device after some predetermined time. This approach is not very satisfying, and indeed can be annoying to the user, if the device is needed for sustained use. Furthermore, for devices such as cell phones, indicators, gauges, or GPS units in use at remote locations or in emergency situations, continued use at low battery charge levels without immediate access to recharge facilities may be necessary, or even critical. Another approach is to simply dim the display, which directly lessens the power draw of the device. This may be acceptable under low light ambient conditions, but is not as acceptable under normal or brighter ambient conditions. Therefore, other power-saving strategies for electronic devices have been developed.

In U.S. Pat. No. 7,012,588, Siwinski describes a method of saving power in a color electroluminescent display, in which the display has red, green and blue light-emitting elements, and additional white light-emitting elements. The white light-emitting elements have a light-emitting efficiency greater than at least one of the red, green or blue colored light-emitting elements. The power-saving mode of the device consists of switching to a monochrome image, in which only the white light-emitting elements are used to display the image. Since the white light-emitting elements have a light-emitting efficiency greater than at least one of the red, green or blue colored light-emitting elements, battery life is extended. In this way a recognizable image may be rendered, although color information is lost.

In U.S. Pat. No. 7,102,632, Siwinski describes another power-saving method for a red, green, and blue element display that does not require the use of an additional white element. This method consists of identifying the colored element of highest luminous efficiency, which is frequently the green element, and switching to a monochrome image that is represented using only the elements of highest luminous efficiency, for example, the green elements. If the green light-emitting elements have a light-emitting efficiency greater than at least one of the red or blue colored light-emitting elements, battery life is extended. In this way some sort of recognizable image may be rendered. However, color information is once again lost, and the green-only monochrome image can be difficult to interpret.

In U.S. Pat. No. 5,598,565, Reinhardt describes a method for screen power saving in which a power-management system is capable of controlling the amount of power delivered to each pixel on a flat-panel display screen. When the power management system either determines that the user has been inactive for a predetermined amount of time, or the display is manually set into a power savings mode, the power management system reduces the power provided to the display pixels that are not within a subset of pixels that have been identified as important pixels on the display. This system requires laborious image processing steps to locate the important pixels on the display.

There is still a need for simple methods of saving power in electroluminescent displays and lighting apparatus that can adjust the device characteristics to extend battery life while maintaining acceptable device performance for some period of time.

### SUMMARY OF THE INVENTION

In accordance with one embodiment that addresses the aforementioned need, the present invention provides a white-light-emitting electroluminescent device that includes light-emitting elements for emitting different colors of light, wherein one of the light-emitting elements has a luminous efficacy greater than the luminous efficacy of at least one of the other light-emitting elements. The different colors of light combine to form white light. Also included is a driver for receiving a color signal representing a relative luminance and color produced by the electroluminescent device. The driver is responsive to a converted control signal when controlling the color accuracy of the light produced by the light-emitting elements to ultimately reduce the power consumption of the white light-emitting electroluminescent device.

Another aspect of the present invention employs a method of controlling a white-light-emitting electroluminescent device that includes:

a) receiving a color signal and a power consumption status signal;

b) converting the color signal to a converted color signal having a reduced color accuracy in response to the power consumption status signal; and

c) driving the white-light-emitting electroluminescent device with the converted color signal to reduce power consumption of the white-light-emitting electroluminescent device;

wherein the white-light-emitting electroluminescent device includes a plurality of light-emitting elements for emitting different colors of light, wherein one of the light-emitting elements has a luminous efficacy greater than the luminous efficacy of at least one of the other light-emitting elements, and wherein the different colors of light combine to form white light.

A third aspect of the present invention is a system that includes a white-light-emitting electroluminescent device having a plurality of light-emitting elements for emitting different colors of light. The different colors of light combine to form white light. Notably, one of the light-emitting elements has a luminous efficacy greater than the luminous efficacy of at least one of the other light-emitting elements. Additionally, a controller receives a color signal and a power consumption status signal, and converts the color signal to a converted color signal having reduced color accuracy. The white-light-emitting electroluminescent device is thereafter driven with the converted color signal.

### BRIEF DESCRIPTION OF THE DRAWINGS

FIG. 1 is a Gaussian model for a QD-LED spectral emission curve, known in the prior art;

FIG. 2 is a 1976 CIE uniform chromaticity scale diagram illustrating the chromaticity coordinates of several hypothetical distributions of QD-LED emitters, according to one embodiment of the present invention;

FIG. 3 is a plot of the relative luminous efficacy for model QD-LED emitters of constant radiant power, according to one embodiment of the present invention;

FIG. 4 is a u′v′ chromaticity space diagram with a Planckian locus of white emitters in accord with the present invention;

FIG. 5 is a plot of the spectral power distributions of several emitters according to one embodiment of the present invention;

FIG. 6 is a schematic of a white-light-emitting electroluminescent device, according to one embodiment of the present invention;

FIG. 7 is a plot of two spectral power distributions, with an inset showing their coordinates in the u′v′ chromaticity space, according to one embodiment of the present invention;

FIG. 8 is a plot of three hypothetical spectral power distributions from a white light electroluminescent light source according to one embodiment of the present invention;

FIG. 9 is a 1976 CIE uniform chromaticity scale diagram illustrating the coordinates of three hypothetical spectral power distributions, according to one embodiment of the present invention;

FIG. 10 is a schematic of a battery-powered white light electroluminescent device suitable for mobile use, according to one embodiment of the present invention;

FIG. 11 is a process diagram of a method of controlling a white-light-emitting electroluminescent device, according to one embodiment of the present invention; and

FIG. 12 is a schematic of a system including a white-light-emitting electroluminescent device according to one embodiment of the present invention.

### DETAILED DESCRIPTION OF THE INVENTION

In recent years, light-emitting diode (LED) devices have included quantum-dot emitting layers to provide large-area light emission. One of the predominant attributes of this technology is the ability to control the wavelength of emission, simply by controlling the size of the quantum dot. This fact has been discussed in a paper by Bulovic and Bawendi, entitled “Quantum Dot Light Emitting Devices for Pixelated Full Color Displays ” and published in the proceedings of the 2006 Society for Information Display Conference. As discussed in this paper, differently-sized quantum dots may be formed and each differently-sized quantum dot will emit light at a different dominant wavelength. This ability to tune light emission provides opportunities for creating narrow-band and, therefore, highly-saturated colors of light emission. Alternatively, broader-band emitters or combinations of emitters can be made to create less saturated colors, or white light. Control of the dominant wavelength and spectral bandwidth allows the designer flexibility in solving a variety of illumination problems.

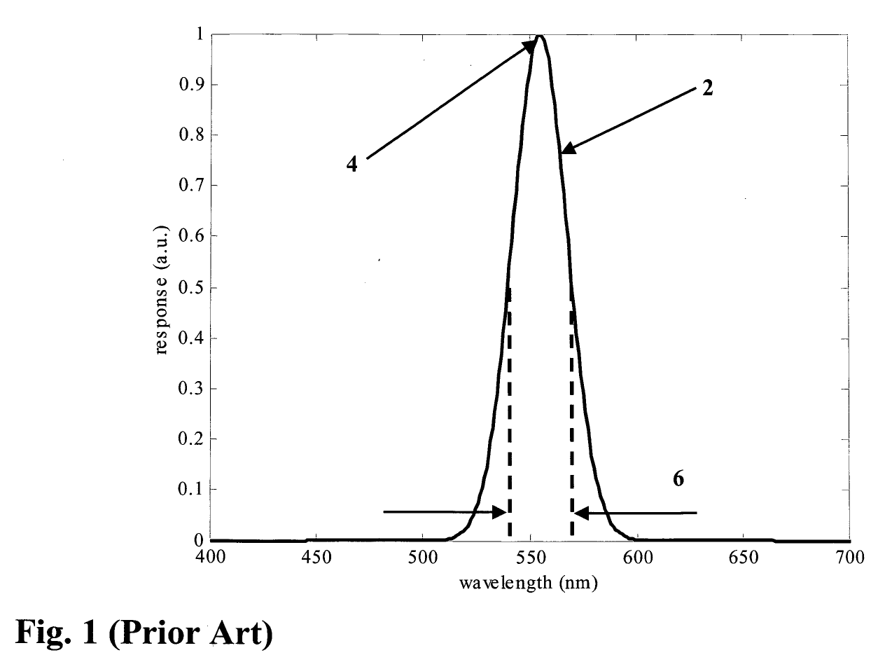

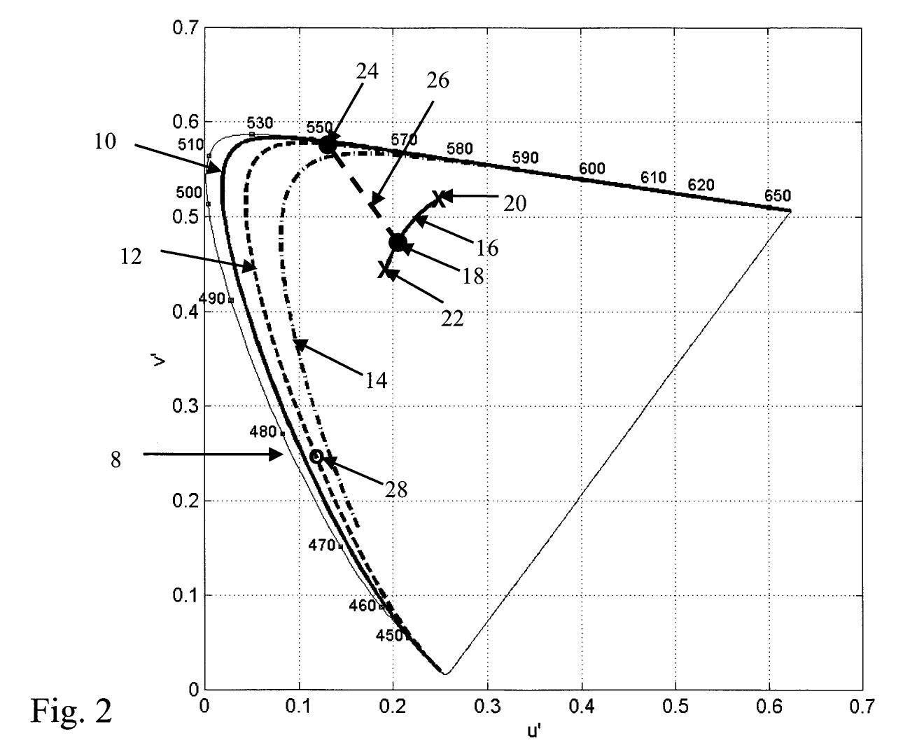

As described in the paper by Bulovic and Bawendi and elsewhere, there is a potential for quantum dot LED (QD-LED) materials to become available that will enable the placement of emitters with peak wavelength at selectable points across the visible spectrum and spectral bandwidths (as measured by the full width at half maximum, or FWHM) on the order of 30 nm. For example, FIG. 1 demonstrates a Gaussian model for a QD-LED spectral emission curve 2 in which the spectral power in arbitrary units (a.u.) is plotted as a function of wavelength in nanometers. The emitter curve includes a peak wavelength 4 and a FWHM 6. FIG. 2 shows a 1976 CIE uniform chromaticity scale diagram illustrating the chromaticity coordinates of several hypothetical distributions of QD-LED emitters. Monochromatic emitters, i.e. emitters of effectively zero FWHM, lie on the spectrum locus 8, which is the horseshoe-shaped curve defining the boundary of visible colors. The chromaticity coordinates from a series of unit-area Gaussian spectral power distributions, whose dominant wavelengths vary continuously all around the u′v′ space for FWHMs of 30, 50 and 80 nm yield the curves 10, 12, and 14, respectively. As expected, the broader the FWHM of the light emitted, the less saturated the color of the light, and the more the curve tends to pull away from the spectrum locus 8. This effect is more pronounced for blue, cyan and green colors, and much less pronounced for yellow, orange and red colors. For reference, a line 16 becomes the locus of white colors associated with blackbody radiators of various temperatures, and is referred to as the blackbody or Planckian locus. As colors become more desaturated (i.e., with increasing FWHM), they tend to approach this region of the chromaticity space.

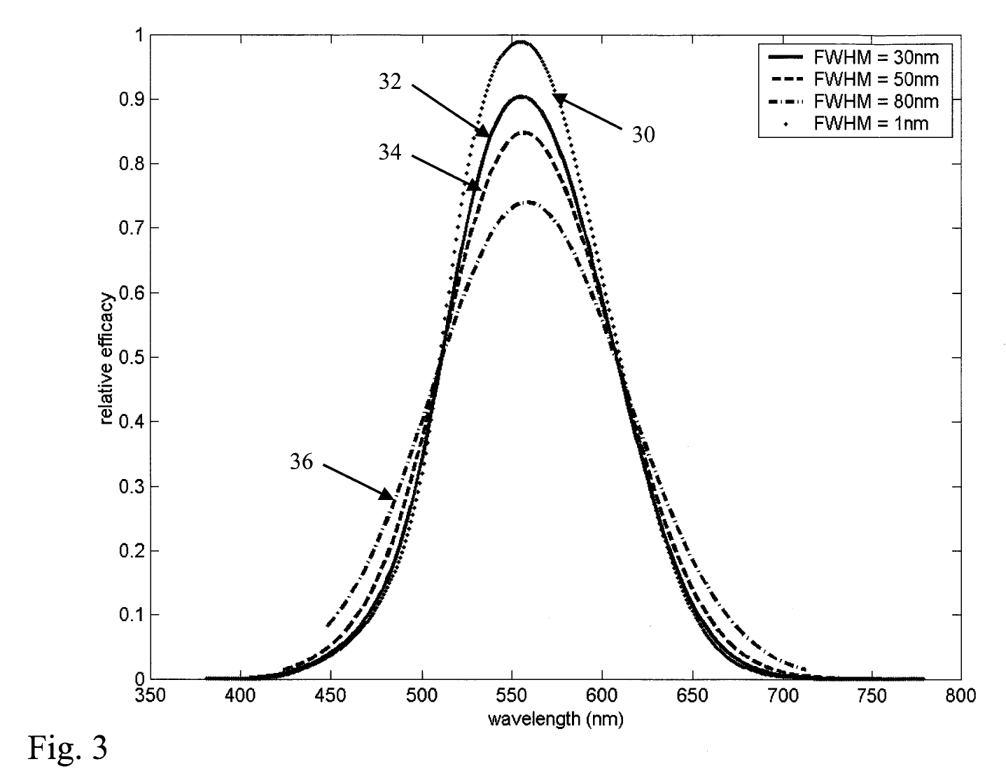

It is known in the art that the human eye is more sensitive to green and yellow light than to red or blue light. That is, for the same amount of radiant power, green wavelengths appear brighter to the observer than shorter or longer wavelengths. This is quantified by the standard spectral luminous efficacy function for monochromatic observers, which peaks at 555 nm for daylight-adapted observers. FIG. 3 plots the relative luminous efficacy for model QD-LED emitters of constant radiant power. This quantity is computed from the equation:

$$ɛ = \frac{\int K ( λ ) s ( λ ) d λ}{\int K ( λ ) d λ}$$

where K(λ) is the spectral luminous efficacy function of the human observer known in the art, s(λ) is the spectral power distribution of the emitter, and λ is the wavelength. In FIG. 3, curve 30 is the relative luminous efficacy for a series of QD-LED emitters whose dominant wavelengths range from 380 nm to 780 nm, with a FWHM of 1 nm. At this very narrow spectral bandwidth, the emitters closely approximate the monochromatic case, and the resulting efficacy curve approaches 1.0 at a wavelength of 555 nm, as expected. FIG. 3 also shows the luminous efficacy curves for the FWHM series just described in FIG. 2, i.e. 30 nm (curve 32), 50 nm (curve 34), and 80 nm (curve 36). It is seen that increasing the FWHM decreases the peak relative efficacy, as wavelengths farther from the peak brightness are included in the radiated power. Further, the peak of the function shifts only slightly to 558 nm as the FWHM increases.

Returning to FIG. 2, white colors are located on or very near to the Planckian locus 16, for example a white point 18. In general, white emitters must be formed from a combination of emitters when the emitters are narrowband, i.e. have a FWHM less than or equal to 50 nm. In a previous, commonly assigned, U.S. application Ser. No. 11/755,037 by Kane et al., included in its entirety herein by reference, methods for obtaining white emitters very near to the Planckian locus 16 using combinations of narrowband emitters are described. This previous application demonstrates how to form efficient whites with two emitters, for example a narrowband yellow and a blue, to obtain white emitters very close to or on the line 16. Furthermore, it is demonstrated therein that the color temperature of a white point composed of a narrowband yellow and a narrowband blue can be varied continuously along the region of the Planckian locus 16 by placing the white point at one end of the locus, for example at or near a point 20, and a second cyan emitter at or near a point 28. Mixed light emitted by emitters at points 20 and 28 can closely approximate the white points along the line 16 up to and including the endpoint 22.

The points along the Planckian locus 16 are a series of colors that are perceived as white when the light-emitting device is the dominant light source in the immediate environment. In the two-dimensional u′v′ chromaticity space of FIG. 2, whites and grays of the same chromaticity map to the same coordinate, regardless of absolute luminance. Considering the maximum device output, the observer perceives the brightest white as the reference white by which other objects are judged. If a device white is moved along the Planckian locus 16, the observer will adapt after a time and will not consider the light to be yellowish if it moves towards point 20, or bluish if it moves towards point 22. Nevertheless, due to spectral content of the light source and the selective reflectance of objects in the surrounding environment, some observers prefer “warmer” (yellower) whites such as at point 20 to “cooler” (bluer) whites such as at point 22. However, such choices have a consequence in terms of a device's power consumption. Generally, the whites that are located closer to the peak of the relative luminous efficacy function in the u′v′ chromaticity space will require less radiant power, and hence less electrical power to achieve the same absolute luminance. Furthermore, colors produced by an emitter located at point 24, which is the peak of the luminous efficacy function, will require much less power to achieve the same absolute luminance, and colors along the direction of line 26 joining this peak point to the Planckian locus 16 (e.g. at white point 18) will also require less power than the whites near or on the Planckian locus itself.

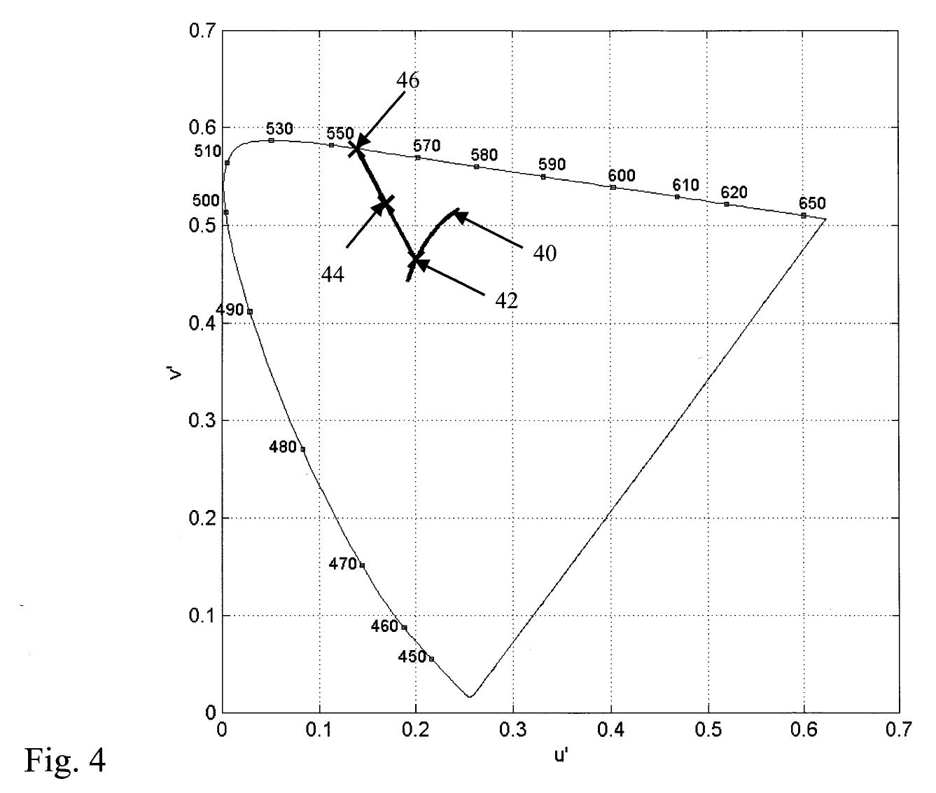

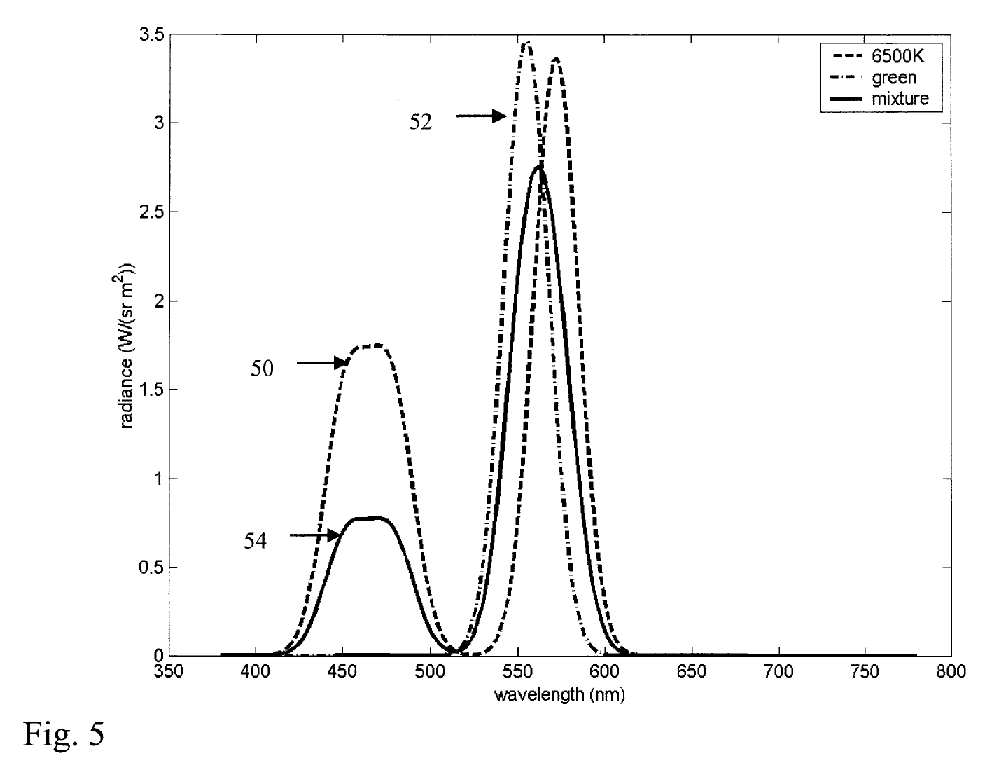

Therefore, in accordance with an embodiment of the present invention, FIG. 4 shows a u′v′ chromaticity space diagram with a Planckian locus 40 of white emitters as a reference. A particular white-light emitter 42 has a correlated color temperature of 6500K. The spectral power distribution of this emitter, which is assumed to have a luminance of 100 cd/m², is shown in FIG. 5 as curve 50. The radiant power of white-light emitter at point 42 is the area under curve 50, and is the power in Watts required to generate a luminance of 100 cd/m² with this spectrum equal to 201.1 W. Referring back to FIG. 4, one would expect that the color at point 46, located near the peak of the spectral efficacy curve, i.e. wavelength 555 nm, could more efficiently generate a brightness of 100 cd/m². The spectral power distribution of this emitter is curve 52 in FIG. 5, and the corresponding radiant power is 110.7 W. Therefore, in one embodiment of the present invention, a substantial power savings (a factor of approximately 1.8) or equivalently, an extension of battery lifetime is realized by allowing the emitted light to change color from the 6500K white to a 555 nm green. In many situations where continuous operation of the device is crucial, the color change will be acceptable. In another embodiment of the present invention, savings in power can be realized with a less drastic change in color. In FIG. 4, the color at point 44 is realized by mixing 42 and 46 in the correct proportions so that the desired luminance of 100 cd/m² is achieved, with a smaller change in color but some savings in power. This emitter spectrum is curve 54 in FIG. 5, and the corresponding radiant power is 150.8 W, a 25% savings. Within the present invention, the amount of power savings desired can be chosen in exchange for a corresponding color shift in the light emitted by the device.

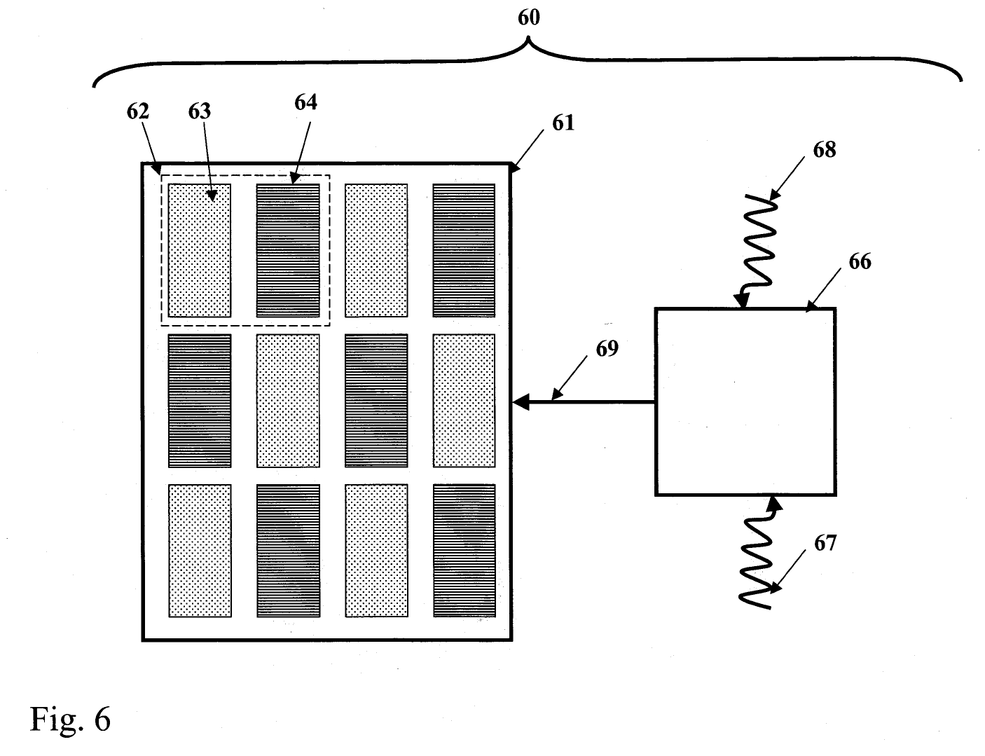

In one embodiment of the present invention, FIG. 6 shows a white-light-emitting electroluminescent device 60, which includes a plurality of light-emitting elements 63 and 64 for emitting different colors of light. A portion 61 of the array of light-emitting elements is shown here. The light-emitting elements are of two different colors 63 and 64, but are not necessarily limited to two, and one color is of higher luminous efficacy than the other color. The groupings 62 of these colors combine to form white light. A driver 66 receives a color signal 68 that represents the relative luminance and color to be produced by the electroluminescent device, and generates a converted color signal for driving the light-emitting elements of the electroluminescent device. The converted color signal is sent to the light-emitting elements over control line 69. The driver is responsive to a control signal 67, and in response to the control signal 67 the driver controls the color accuracy of the light produced by the light-emitting elements to reduce the power consumption of the device 60. In this embodiment, light-emitting element 63 is positioned at point 20 in the u′v′ chromaticity space (see FIG. 2), and light-emitting element 64 is positioned at point 28 in the u′v′ chromaticity space. In this embodiment, driver 66 controls the color accuracy by varying the white along a line joining 20 and 28 (not shown), which closely follows the Planckian locus 16, and saves power by moving the white from the bluish end 22 of the Planckian locus toward the yellowish end 20, the yellowish end having higher luminous efficacy.

In one embodiment of the present invention, the control signal 67 received by the driver 66 is a power consumption status signal output by an electronic device connected to the white-light-emitting electroluminescent device. For example, a white-light-emitting electroluminescent backlight in an LCD display used in a mobile device such as a cellular telephone may receive a power consumption status signal from a telephone controller, indicating that the cellular telephone is in a state of rapidly declining battery charge. In response to this information, the driver 66 may automatically adjust the color accuracy of the display by shifting its white point towards a color of higher luminous efficacy to save power. Driver 66 may shift the white point gradually towards a predetermined point, as battery charge gradually declines, thus reducing a user's perception of the change. Alternatively, driver 66 may shift the white point in a series of one or more steps, based on a series of reference battery charge levels, towards the predetermined white point. The control of the power savings via color accuracy can be enabled as an automatic function of the driver or as a manual user selectable switch. The device enabling the power savings function can alert the user as to the low-charge condition and present as an option to change the color accuracy of the display. The device can offer the option to disable the power savings function when plugged in to a charger or wall outlet.

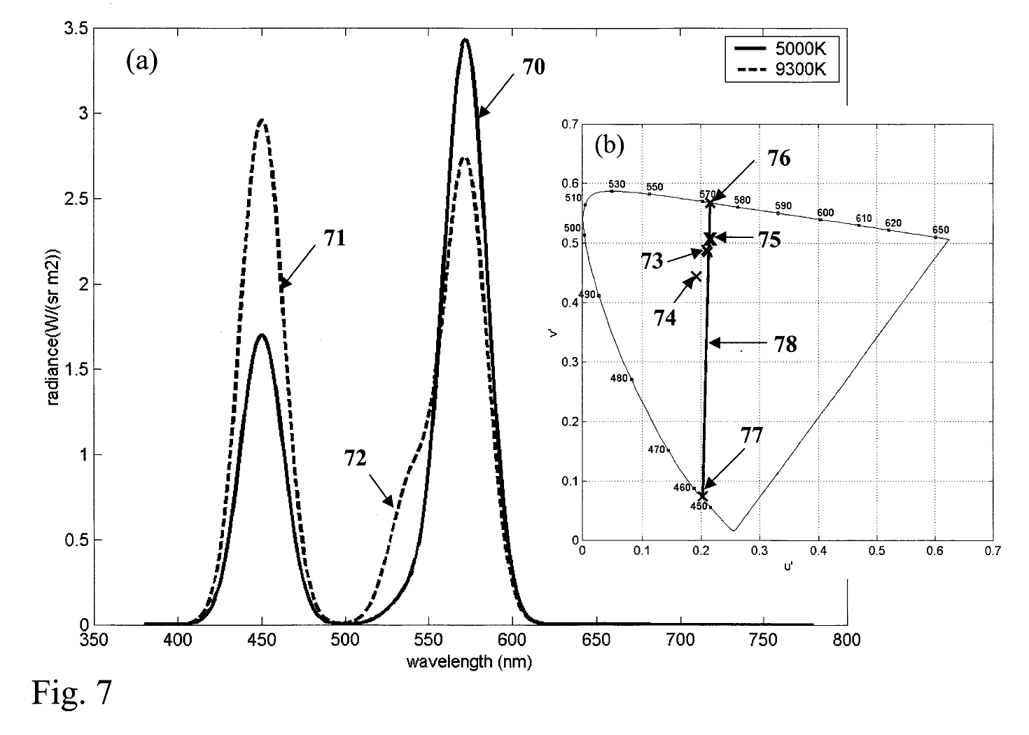

In one embodiment of the present invention, the color of the light produced by the light-emitting elements is white light that includes two or more component colors. For example, FIG. 7a shows two spectral power distributions 70 and 71 that produce white light of correlated color temperature 5000K and 9300K, respectively, at a fixed luminance of 100 cd/m². Each distribution is made up of at two prominent narrowband spectral components centered at peak wavelengths 452 nm and 572 nm, mixed in different proportions to obtain the different color temperatures at opposite ends of the Planckian locus. Inset FIG. 7b shows the locations of the white points 73 and 74 formed by the spectra 70 and 71, respectively, in the u′v′ chromaticity space. The locations of the narrowband components at 452 nm and 572 nm are also shown in FIG. 7b as points 76 and 77. It is well known in the art that all color combinations formed by a mixture of these two points lie on the straight line 78 joining them in the chromaticity space. It is clear that white point 74 does not lie on the line 78, and even white point 73 can be seen to lie a little to the left of the line. In fact, there is a third narrowband component in the mixture, centered at 540 nm, the effect of which is manifested in the curve 71 by the tail 72 on the 572 nm component, but not readily observed in the curve 70, due to its relatively small proportion in the mixture. Note that the total area under the curve 70, which gives the radiant power needed to output the 100 cd/m² luminance, is smaller than the total area under the curve 71. The resultant radiant powers are 169 W and 207 W, respectively, showing the reduced-power advantage of shifting the white point from point 74 towards the region of higher luminous efficacy, i.e. towards point 73.

In another embodiment of the present invention, FIG. 7b shows a white point 75 that lies exactly on the line 78, and is composed entirely of the two narrowband component colors 76 and 77. In this embodiment, narrowband component colors 76 and 77 are each associated with a different light-emitting element, wherein one of the two light-emitting elements emits light of a complementary color to the other of the two light-emitting elements. As the color shifts more towards element 76, the luminous efficacy is increased and power is saved. Shifting the color towards element 77 decreases the luminous efficacy and results in higher power use for the same overall luminance output, but can be done in response to the preference of the device user. In one embodiment of the present invention, power is saved by shifting the color of the light output by the device towards the color of the light-emitting element of highest luminous efficacy. In one such embodiment, the light-emitting element of highest luminous efficacy has a dominant wavelength between 550 nm and 560 nm. Placement of the light-emitting element of highest luminous efficacy at this dominant wavelength is consistent with FIG. 3. In another embodiment, power is saved by shifting the color of the light output by the device away from the color of the light-emitting element of lowest luminous efficacy.

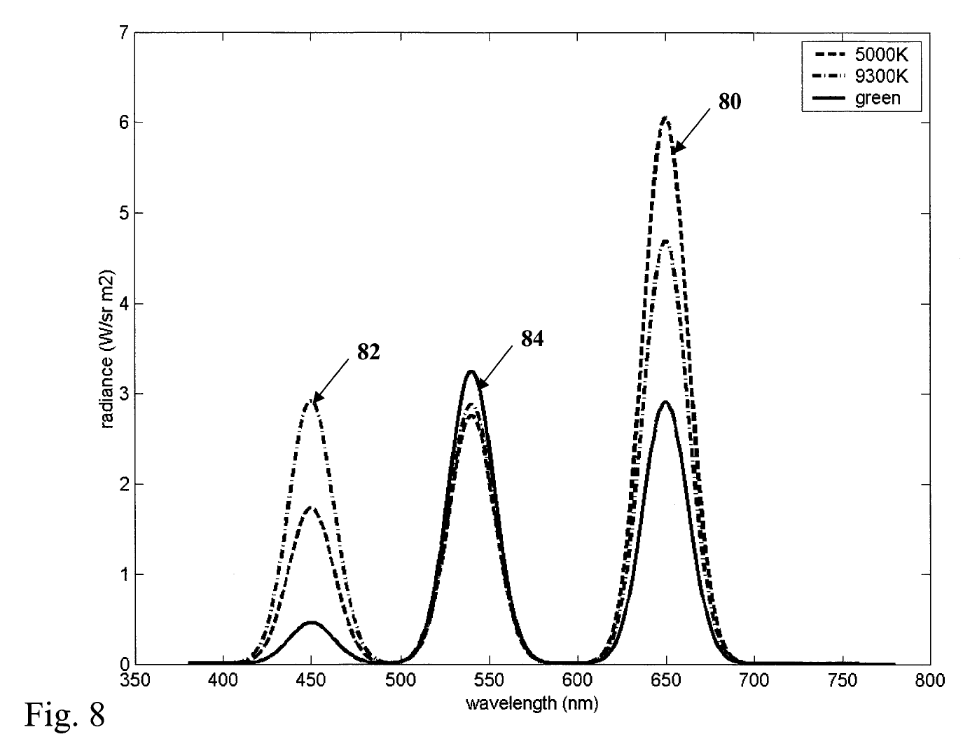

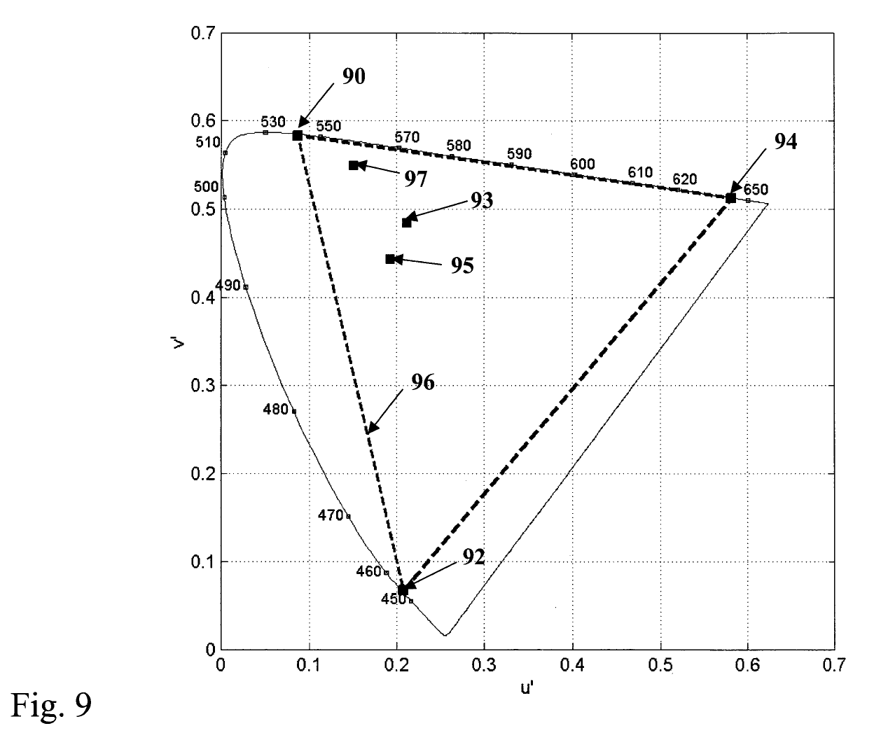

In another embodiment of the present invention, the device has three light-emitting elements, wherein the three light-emitting elements emit three different primary colors of light. FIG. 8 shows three hypothetical spectral power distributions 80, 82 and 84 from such a device, each comprising emissions from three narrowband emitter components located in the red, green and blue regions of the spectrum, i.e. the primary colors well-known in the art. The three curves represent different mixtures of the three components used to achieve different white points in a white-light-emitting electroluminescent device. Curve 80 matches a 5000K correlated color temperature, curve 82 matches a 9300K correlated color temperature, and curve 84 matches a non-white (green) color used in a power-saving mode. FIG. 9 shows the locations of these colors in the u′v′ chromaticity space, with the curves 80, 82 and 84 corresponding to the points 93, 95 and 97 respectively. FIG. 9 also shows the locations of the primaries 90, 92 and 94, as well as the triangular gamut 96 encompassed by these primaries. From FIG. 8 it is clear that curves 80 and 82 trade off energy in the red and blue to adjust the color temperature from 5000K to 9300K, and have about equal energy in the green. With this particular choice of green primary, the radiant power consumed by the 100 cd/m² white by emitters corresponding to curves 80 and 82 are very similar; the result is 336.9 W at 500K and 335.5 W at 9300K. The power consumption in this three-primary case is dominated by the power needed to drive the saturated red and blue primaries. More savings are realized by shifting the white point off the Planckian locus and towards the green region of the chromaticity space, where again the luminous efficacy is highest. This means driving the green primary harder and de-emphasizing the red and blue, or moving the white towards point 97 in FIG. 9. In FIG. 8, it is clear that the corresponding curve 84 has much less area; the resulting radiant power for 100 cd/m² is 211.3 W, a substantial savings in power.

In some embodiments of the present invention, the light-emitting elements include organic light-emitting diodes (OLEDs), such as small-molecule devices as reported by Tang et al (Applied Physics Letters 51, 913, 1987), or polymeric devices as reported by Burroughes et al (Nature 347, 539, 1990). In other embodiments, the light-emitting elements include core shell quantum dots in a poly-crystalline semi-conductor matrix, as discussed in co-pending U.S. application Ser. No. 11/226,622, filed Sep. 14, 2005 by Kahen, hereby included by reference. In such an embodiment, it is possible to mix species of core-shell quantum dots and deposit them into a single layer, such that one light-emitting element emits two or more different colors of light. For example, in FIG. 8, one element may contain two species of core-shell quantum dots emitting red and blue light, while another element contains core-shell quantum dots emitting green light. In this example, the red and blue light can be emitted in a fixed relative proportion, while the proportion of green to red and blue light can be controlled for purposes of power savings.

The invention can be applied to displays comprised of white-light-emitting electroluminescent elements, wherein the driver 66 of FIG. 6 reduces the power consumption by shifting the color of the white point of the display. This differs from the prior-art methods of U.S. Pat. No. 7,012,588 and U.S. Pat. No. 7,102,632, wherein power consumption is reduced by switching the display to a monochrome mode. In U.S. Pat. No. 7,012,588, this entails use of white-light-emitting pixels only, while U.S. Pat. No. 7,102,632 entails the use of the colored pixels having the highest luminous efficiency only, for example, green pixels. In the present invention, the image is not rendered in monochrome, but rather the white point is shifted to a more efficient position and color accuracy is traded for power consumption. This may entail a shift along the Planckian locus, so that the white point remains what observers would perceive as a different shade of white, but still white. Alternatively, a larger trade in color accuracy can shift the white point farther from the Planckian locus, so that, depending on the environment, the observer may or may not completely adapt to the shift, and may perceive a definite color cast to the adjusted image. This shift may be completely acceptable, however, depending on the image content, the application (pictorial vs. informational), and the state of the device (freshly charged vs. depleted). Image transforms for implementation of small white point shifts, along or near the Planckian locus, can be based on the Von Kries transform (E. J. Giorgianni and T. E. Madden, Digital Color Management: Encoding Solutions, Addison-Wesley, Reading, Massachusetts, 1998, pp. 479-481.). Larger white-point shifts can be implemented by the use of color magnets as explained in U.S. Pat. No. 6,894,806, wherein specific points or areas in color space can be transformed while other areas are left unaffected. That is, the color magnet technique can be applied to transform the colors in the area around the white point to a new, more efficient area in color space while leaving other colors unaffected, or affected them in a prescribed and pleasing way. This differs importantly from the prior art method of U.S. Pat. No. 5,598,565, wherein pixels are identified in the image based on their importance according to some usage criterion, and then selectively brightened, while the unselected pixels are selectively dimmed. The present invention transforms pixels based on a quantitative, color space and device-based criterion and does not perform selective brightening or dimming.

The invention can also be applied to general-purpose lighting fixtures, wherein the driver 66 of FIG. 6 reduces the power consumption by shifting the color of the white light output by the device. Once again, the white point shift may be along the Planckian locus such that the perceived color remains white, or away from the Planckian locus such that a noticeable hue change occurs, depending on the local environment and the degree of observer adaptation. In either case, color accuracy is traded for reduced power consumption, which may be acceptable depending on the state of the device.

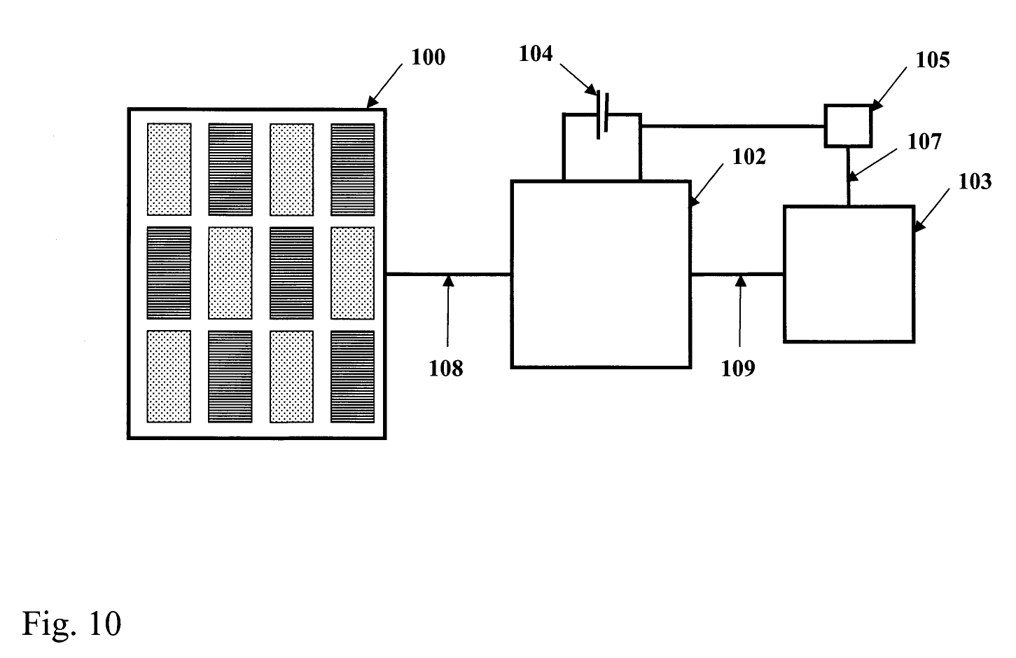

As described earlier, the control signal received by driver 66 can be a power consumption status signal output by an electronic device connected to the white-light-emitting electroluminescent device. In one embodiment of the present invention, the device is a battery-powered device suitable for mobile use, wherein the device includes a battery-charge sensor that determines the amount of charge remaining in the battery, and a controller for sending a control signal to the driver 66 when the charge remaining in the battery has reached a predetermined level. FIG. 10 shows a schematic of such a device. The electroluminescent device 100 in this case is a white-light-emitting electroluminescent device that includes a plurality of light-emitting elements for emitting different colors of light, a portion of which is shown in FIG. 10. A driver 102 generates a converted color signal for driving the light-emitting elements of the electroluminescent device. The converted color signal is sent to the electroluminescent device over the control line 108. A controller 103 is also connected to the driver 102 and sends a signal to it over the control line 109. A battery 104 powers the device and is connected through the driver 102 such that it supplies power to the electroluminescent device, also over the control line 108. A battery charge sensor 105 determines the amount of charge remaining in the battery 104 by monitoring the current supplied to the controller 102 and sends a battery status signal to the driver 103 over the control line 107. When the charge in the battery 104 has reached a predetermined level, the driver 103 signals the controller 102 to change the white point of the electroluminescent device 100 so as to consume less power and extend the operational life of the device before battery recharging becomes necessary.

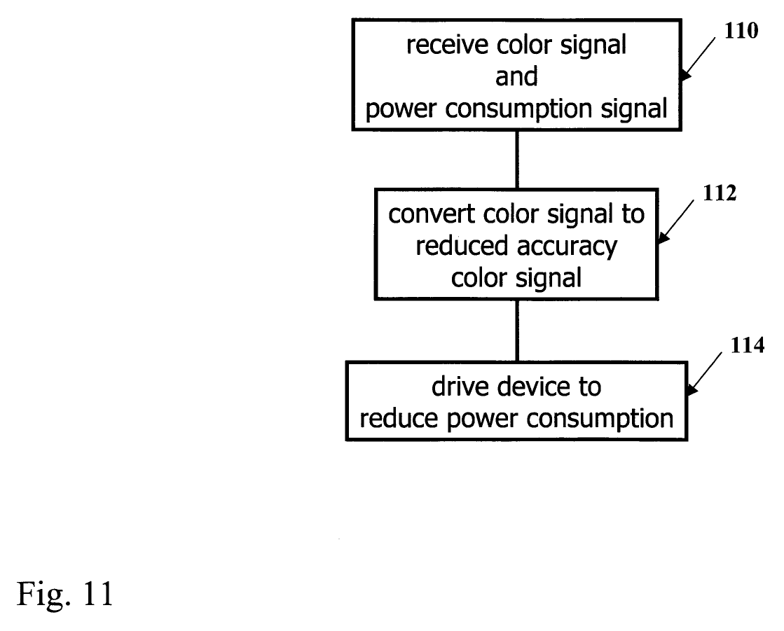

The present invention also includes a method of controlling a white-light-emitting electroluminescent device, which as shown in FIG. 11 comprises the steps of 110: receiving a color signal and a power consumption status signal, 112: converting the color signal to a converted color signal having a reduced color accuracy in response to the power consumption status signal, and 114: driving the white-light-emitting electroluminescent device with the converted color signal to reduce power consumption of the white-light-emitting electroluminescent device.

In one embodiment of the present invention, the converted color signal is a luminance signal or has a relatively increased luminance component compared to the color signal. The processing of RGB color signals into so-called luminance and chrominance signals is known in the art (see for example E. J. Giorgianni and T. E. Madden, Digital Color Management: Encoding Solutions, Addison-Wesley, Reading, Mass., 1998, pp. 274-278). In this context, luminance refers to the usual Y tristimulus value, and chrominance refers to signals corresponding to CIE chromaticity coordinates (x,y or u′v′). Since the luminance signal is an achromatic signal and is based on the spectral luminous efficacy function, it will consume less radiant power to display, since it is brighter to the eye. The chrominance signals use more power to display since they contain information about saturated color content, for example, the red and blue colors that lie farther away from the region of greater luminous efficacy in the chromaticity space. Shifting the white point of the display will impact primarily the luminance component of the signal, with little impact on the chrominance components, simplifying the processing.

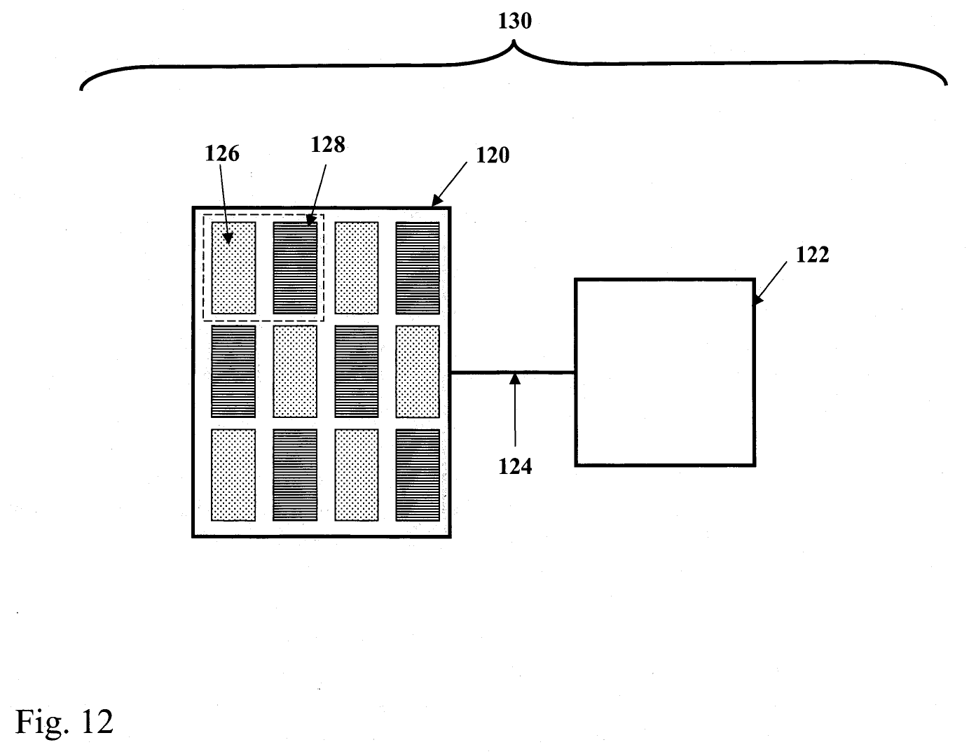

The invention as described further includes a system 130 as shown in FIG. 12 comprising a white-light-emitting electroluminescent device 120 including a plurality of light-emitting elements 126 and 128 for emitting different colors of light, wherein one of the light-emitting elements has a luminous efficacy greater than the luminous efficacy of at least one of the other light-emitting elements, and wherein the different colors of light combine to form white light, and a controller 122 for receiving a color signal and a power consumption status signal over the control line 124, and converting the color signal to a converted color signal having a reduced color accuracy and driving the white-light-emitting electroluminescent device with the converted color signal.

The invention has been described in detail with particular reference to certain preferred embodiments thereof, but it will be understood that variations and modifications can be effected within the spirit and scope of the invention.

PARTS LIST

| | |
|---|---|
| 2 | spectral emission curve |
| 4 | peak wavelength |
| 6 | full width half maximum |
| 8 | spectrum locus |
| 10 | locus of chromaticity coordinates |
| 12 | locus of chromaticity coordinates |
| 14 | locus of chromaticity coordinates |
| 16 | Planckian locus |
| 18 | white point |
| 20 | white point |
| 22 | white point |
| 24 | chromaticity point of peak luminous efficacy |
| 26 | line joining chromaticity point of peak luminous efficacy and |
| | Planckian locus |
| 28 | chromaticity point |
| 30 | relative luminous efficacy curve |
| 32 | relative luminous efficacy curve |
| 34 | relative luminous efficacy curve |
| 36 | relative luminous efficacy curve |
| 40 | Planckian locus |
| 42 | chromaticity point |
| 44 | chromaticity point |
| 46 | chromaticity point |
| 50 | spectral power distribution |
| 52 | spectral power distribution |
| 54 | spectral power distribution |
| 60 | white-light-emitting electroluminescent device |
| 61 | portion of array of light-emitting elements |
| 62 | grouping of pixels |
| 63 | light-emitting element |
| 64 | light-emitting element |
| 66 | driver |
| 67 | control signal |
| 68 | color signal |
| 69 | control line |
| 70 | spectral power distribution |
| 71 | spectral power distribution |
| 72 | tail of spectral power distribution |
| 73 | white point |
| 74 | white point |
| 75 | white point |
| 76 | component color |
| 77 | component color |
| 78 | line joining components colors |
| 80 | spectral power distribution |
| 82 | spectral power distribution |
| 84 | spectral power distribution |
| 90 | chromaticity coordinate of primary |
| 92 | chromaticity coordinate of primary |
| 93 | white point |
| 94 | chromaticity coordinate of primary |
| 95 | white point |
| 96 | triangular gamut |
| 97 | chromaticity coordinate of green color |
| 100 | electroluminescent device |
| 102 | driver |
| 103 | controller |
| 104 | battery |
| 105 | battery charge sensor |
| 107 | control line |
| 108 | control line |
| 109 | control line |
| 110 | process step: receive signals |
| 112 | process step: convert signal |
| 114 | process step: drive device |
| 120 | white-light-emitting electroluminescent device |
| 122 | controller |
| 124 | control line |
| 126 | light-emitting element |
| 128 | light-emitting element |
| 130 | system |

What is claimed is:

1. A white-light-emitting electroluminescent device, comprising:
a. a plurality of light-emitting elements for emitting different colors of light, wherein one of the light-emitting elements has a luminous efficacy greater than the luminous efficacy of at least one of the other light-emitting elements, and wherein the different colors of light combine to form white light; and
b. a driver for receiving a color signal representing a relative luminance and color produced by the electroluminescent device, and generating a converted color signal for driving the light-emitting elements of the electroluminescent device, wherein the driver is responsive to the control signal and controls the color accuracy of the light produced by the light-emitting elements to reduce the power consumption of the white light-emitting electroluminescent device.

2. The device claimed in claim 1, wherein the driver receives a power consumption status signal and wherein the driver responds to the power consumption status signal to control the color accuracy of the light-emitting elements.

3. The device claimed in claim 1, wherein the color of the light produced by the light-emitting elements is on a Planckian locus of a CIE chromaticity curve.

4. The device claimed in claim 1, wherein the color of the light produced by the light-emitting elements is white light including two or more colors.

5. The device claimed in claim 1, wherein the converted color signal is a luminance signal or has a relatively increased luminance component compared to the color signal.

6. The device claimed in claim 1, wherein the device has two light-emitting elements, wherein one of the two light-emitting elements emits light of a complementary color to the other of the two light-emitting elements.

7. The device claimed in claim 1, wherein the device has three light-emitting elements, wherein the three light-emitting elements emits three different primary colors of light.

8. The device claimed in claim 1, wherein the device has a plurality of light-emitting elements emitting different colors of light, and wherein one of the light-emitting elements emits two or more different colors of light.

9. The white light-emitting electroluminescent device of claim 1, wherein the driver reduces the power consumption by shifting the color of the light output by the device towards the color of the light-emitting element of highest luminous efficacy.

10. The white light-emitting electroluminescent device of claim 1, wherein the driver reduces the power consumption by shifting the color of the light output by the device away from the color of the light-emitting element of lowest luminous efficacy.

11. The white light-emitting electroluminescent device of claim 2, wherein the light-emitting element of highest luminous efficacy has a dominant wavelength between 550 nm and 560 nm.

12. The white light electroluminescent device of claim 1, wherein the device is a display, and the driver reduces the power consumption by shifting the color of the white point of the display.

13. The white light electroluminescent device of claims 1 through 4, wherein the device is a general purpose lighting fixture, and the driver reduces the power consumption by shifting the color of the white light output by the device.

14. The white light electroluminescent device of claim 1, wherein the device is a battery-powered device suitable for mobile use.

15. The white light electroluminescent device of claim 7, wherein the device includes:
a. a battery charge sensor that determines the amount of charge remaining in the battery; and
b. a controller for sending a control signal to the driver when the charge remaining in the battery has reached a predetermined level.

16. The device claimed in claim 1, wherein the light-emitting elements include core shell quantum dots in a poly-crystalline semi-conductor matrix.

17. The device claimed in claim 1, wherein the light-emitting elements include organic light-emitting diodes.

18. A method of controlling a white-light-emitting electroluminescent device comprising the steps of:
a. receiving a color signal and a power consumption status signal;
b. converting the color signal to a converted color signal having a reduced color accuracy in response to the power consumption status signal; and
c. driving the white-light-emitting electroluminescent device with the converted color signal to reduce power consumption of the white-light-emitting electroluminescent device;
wherein the white-light-emitting electroluminescent device includes a plurality of light-emitting elements for emitting different colors of light, wherein one of the light-emitting elements has a luminous efficacy greater than the luminous efficacy of at least one of the other light-emitting elements, and wherein the different colors of light combine to form white light.

19. The method of 18, wherein the white-light-emitting electroluminescent device includes a plurality of light-emitting elements emitting different colors of light that when combined form a white light having two or more colors.

20. A system comprising:
a. a white-light-emitting electroluminescent device including a plurality of light-emitting elements for emitting different colors of light, wherein one of the light-emitting elements has a luminous efficacy greater than the luminous efficacy of at least one of the other light-emitting elements, and wherein the different colors of light combine to form white light;
b. a controller for receiving a color signal and a power consumption status signal, and converting the color signal to a converted color signal having a reduced color accuracy and driving the white-light-emitting electroluminescent device with the converted color signal.
